(19) United States
(12) Patent Application Publication
(10) Pub. No.: US 2017/0246084 A1
(43) Pub. Date: Aug. 31, 2017

(54) Medical transport bag

(71) Applicant: Sahar M. H Jaffal, Boston, MA (US)

(72) Inventor: Sahar M. H Jaffal, Boston, MA (US)

(21) Appl. No.: 15/427,637

(22) Filed: Feb. 8, 2017

Related U.S. Application Data
(60) Provisional application No. 62/388,796, filed on Feb. 8, 2016.

(51) Int. Cl. A61J 1/16; A45C 13/10; A45C 13/26; F25D 29/00; F25D 11/02; F25D 11/00; F25D 31/00; A45C 13/00; A45C 11/00

(52) U.S. Cl. CPC A61J 1/165; A45C 13/008; A45C 13/103; A45C 13/26; A45C 11/00; F25D 11/027; F25D 11/00; F25D 31/005; F25D 29/008; F25D 29/00; A45C 2011/007

(57) ABSTRACT

Several travel bags, carriers and coolers are available in the market. However, these carriers are suitable for transporting drugs under one condition and don't serve many of the patients (and in particular the elderly) who have prescribed drugs that need to be stored at different temperatures in one unit. These carriers are, also, costly and aren't tailored to solve the problems that encounter many researchers in the labs and many patients. Accordingly, they were not effective in solving the problems of the waste of the drugs due to their improper storage or in preventing the adverse effects that can result from the damage of the drugs.

In contrast, the Medical Transport Bag is an economic transport system that can be used for transporting many samples and medicines in a cost-effective manner and under different controlled conditions in the same unit.

### CROSS-REFERENCE TO RELATED APPLICATION

The application for this invention claims the benefit and priority to the U.S. Provisional Patent Application No. 62/388,796, Filing date: Feb. 8, 2016.

### TECHNICAL FIELDS THAT ARE RELATED TO THE INVENTION & THE PROBLEMS THAT THE INVENTION SOLVES

This invention relates to the Medical Transport Bag. The bag enables the transport of the drugs and samples under optimal stabilized conditions and can be used in our daily life and in several fields: Medicine, Cell Biology, Microbiology, Environmental protection centres, Chemistry, Physics, Geology, Agriculture and other fields.

The invention allows the transport of many chemicals/drugs that need different storage conditions at the same time in the same bag and accordingly saves the time, efforts and money of the researchers and patients.

The Medical Transport Bag is also practical for the users and allows the transport/storage of the drugs safely at fixed temperature (cold- or warm- or room temperature). Accordingly, it has a practical applicability in the daily life of the patients and other users.

Although the bag can be ideal for maintaining room temperature if the warm or cold temperatures are not needed, the bag will include a place for the safe storage of the medicines/chemicals/consumables (e.g. needles, syringes, storing small containers such as day-by-day pill boxes) that need to be placed at room temperature so that they can be used if the compartments of the warm and cold temperatures are in use.

Additionally, this invention saves the efforts of the users (e.g. pharmacists) in keeping and watching the calibrated thermometer in several areas of the room to identify the hottest and the coldest areas of the room and adjust the temperature in them.

It is also useful in protecting the photosensitive drugs, laboratory supplements and health products (e.g. x-ray films, male condoms, furosemide, vitamins, hydrocortisone, chloropheniramine maleate) that need to be protected from light in order to avoid their damage and the loss or reduction of the therapeutic activity of the drugs.

The Medical Transport Bag will help in overcoming the confusion that occurs when the patients (in particular the elderly) read the labeling instructions regarding the storage of the drug at room temperature. The storage at room temperature can be confusing because the weather can be extremely hot in summer or extremely cold and can differ based on the available machines in the place. The Medical Transport Bag is a convenient and affordable way to store different medicines under suitable controlled conditions in one piece regardless of the storage conditions.

Other advantage for the Medical Transport Bag is that it is helpful in decreasing the confusion in applying the disposal rules of the drugs by decreasing the number of damaged/disposed drugs. The Food and Drug Administration (FDA) determined list of drugs that need to be flushed in the toilet due to potential harm. However, other drugs are not recommended to be flushed and should be thrown in the trash as the following: 1) Dissolving the solid pills in water or crushing them then 2) The addition of the sawdust or coffee grounds to prevent eating them by pets or children 3) Finally, sealing the bag and throwing it in the trash) to avoid environmental effects. The reason for these recommendations is that the sludge from the wastewater is used as fertilizer in agriculture and accordingly the disposal of pharmaceutics in the toilet will lead to the leakage of pharmaceutical compounds in the environment as it was detected by several studies.

In addition, this invention is functional in the countries that don't apply waste management and the disposal in an environmentally friendly way and especially that not all the countries are offering unwanted medicines collection programs. Accordingly, the use of the Medical Transport Bag saves the state and the country a lot of money due to the efforts and the financial burdens that are needed for disposing these medicines in environmentally friendly way. According to some studies, the cost of incinerating 4.1 kg of pharmaceutics is $8.2 million. This is considered huge cost and can impose a burden on the economic system of the countries.

Moreover, the Medical Transport Bag is helpful in avoiding the worst cases in which there is continuation for taking the medicine and over the counter products despite the fact that they are ineffective. These medicines/products can be damaged due to their exposure to extreme temperatures without the awareness of the patients/users that the damage occurred and that they are ineffective prior to the expiration date. The reason is that the drug can be damaged without showing the physical signs of being damaged (e.g. change in the smell or texture/showing marked separation). Therefore, the Medical Transport Bag is valuable in preserving the drugs/medicines and over the counter products at fixed temperatures.

The Medical Transport Bag is also useful for preserving medicines and over the counter products during the travel for long period of time, during transit and when there is more than a way of travelling (bus, car, plane . . . etc). The carry-on luggage and the hand bag aren't provided with suitable conditions for preserving medicines and drugs. In addition, the weather and the environment of the place in which the user is travelling to can be unpredictable and can lead to the damage of the life sensitive drugs unless the user has a suitable transport bag. Another reason that adds to the importance of having a Medical Transport Bag is that many of the hotels and hostels don't provide refrigerators in the room and this increases the importance of using the Medical Transport bag that I am providing in this invention.

According to several studies, the following events are the most common causes that lead to the damage of several drugs and products and adds more weight to the importance of having the Medical Transport Bag:
1) The bag is helpful if the patient left, accidently, a prescribed medicine and over the counter products in the car or other place.
2) It is also advantageous for the important medicines and over the counter products if the power of the refrigerator went off suddenly.

Additionally, the bag is useful for the elderly as it includes an alarm system that will alert the patient for the time of taking the medicine and for other information (e.g. expiration date, the doses or the time of taking the drugs and the improper conditions for storing the drugs) that can be stored in the software in every compartment of the bag.

On the other hand, the Medical Transport Bag is valuable for the researchers who are working in the laboratories and need to transport/keep a lot of drugs, chemicals and products under fixed conditions or away from the light. It helps in avoiding the inaccurate experimental results that may result from the improper storage conditions of the drugs and the chemicals.

### BACKGROUND INFORMATION AND PRIOR ART

Pharmaceuticals should be stored under certain conditions that are determined by the manufacturing company to avoid the adverse reactions and to achieve the intended uses of the drugs and health products.

Also, the chemicals, the laboratory needs and the materials that are used in the experimental research needs to be maintained at fixed conditions.

Maintaining temperature is an important factor that should be taken into consideration in the scientific/medical experiments & when transporting/handling drugs that are sensitive to life.

Little changes in the temperature of the samples and/or the drugs can affect the experiment and lead to inaccurate results. It can, also, affect the safety and the shelf life of certain drugs that are important for the lives of the patients.

For example, a simple change in the conditions of the growth media can cause toxicity, cell death and inaccurate results that can be reported and analyzed by the researcher as results of the experiment while the results emerged from the improper handling of the media and the reagents. This will lead, also, to the loss of the money, time and efforts of the researchers.

The followings are further details of the costs that the researcher can lose due to a simple change in the conditions of the experiment: the cost of buying and culturing cells, the cost of the growth media and the required supplements, the cost of the animals and their housing in case of using animals for extracting cells, the cost of maintaining the incubator, the costs of the inhibitors and the drugs that were used in the experiment, the cost of the antibodies, films and membranes and gels of western blot . . . etc.

Although several medicines and over the counter products can be stored at room temperature, the case isn't the same for all medicines and products as many of them need more specific conditions (https://www.agingcare.com/articles/extreme-temperatures-may-affect-medication-152125.htm). The following paragraph includes few examples of the drugs/medicines and over the counter products that need specific storage conditions:
1) Injectable drugs for diabetes (e.g. Insulin, Victoza, symlin & Byetta).
2) Inhaled medications (e.g. Foradil & Brovana).
3) Eye drops (e.g. Xalatan, Travatan Z, Travatan, Azacite & Phospholine Iodide).
4) Others (Octreotide, Forteo, Copaxone & Fortical-calcitonin Nasal spray).

Pharmaceutics recommend storing drugs at controlled fixed temperature (from 68 to 77° F.). Drugs that are exposed to extreme temperatures (during hot or cold weather) are subject to change in the physical appearance/the structure, losing the potency of the drug and can threaten the life of the patient.

If medications were subjected to extreme temperatures, this could render the medication dangerous or ineffective for the patients who use them. The patients can request replacement prescription of the drug. However, there is a financial loss in addition to severe adverse effects on the health of patients because of taking expired or ineffective “deteriorated drug error”. For example, 1) Taking expired or ineffective nitroglycerin can be fatal for heart patients. 2) Taking expired or ineffective tetracycline can be poisonous. 3) Taking expired or ineffective aspirin can be harmful.

The problem lies in the fact that the drug can be damaged without showing signs of deterioration such as changing in its color, odor or consistency and accordingly, the patients can take damaged drugs without noticing or knowing that it is damaged.

The following is a live story that was mentioned by Mr. Walecia Konrad whose 10 years old son took a medication for allergy when they were in a trip to the lake and was not responding to it even after taking the next dose and the third one (http://www.nytimes.com/2011/08/16/health/16consumer.html). The man started to ask pharmacists and professors about the reason thinking that his son became immune to the drug. Later, the man got the answer from Dr. Skye McKennon who works as a clinical assistant professor at the University of Washington School of Pharmacy as the following: “Pharmaceutical manufacturers recommend most of their products be stored at a controlled room temperature of 68 to 77° F.”, “During heat waves and cold spells, storage locations can go above or below those ranges, causing medicines to physically change, lose potency or even threaten your health”. The man realized that the irresponsiveness of his son to the medicine was due to storing his medication in the bathroom shelf and in the hot weather in the car during their trip to the lake.

According to Dr. McKennon, there is no evidence that the expensive bubble to foil pack can serve the drug better than the pill bottle. Therefore, there is a need for a convenient way that allow the users to store the drugs and the medical products at fixed conditions.

In addition, several case studies were published in several articles about patients who died because of using expired or compromised medicines. The following case studies were published in an article entitled “Latest round of California hospital errors include patient deaths” Dec. 9, 2011:

The case study indicates that 2 elderly patients died of pneumonia after receiving ineffective vaccine against pneumonia while several hundreds were hospitalized at the Kaiser Foundation Hospital in South San Francisco, a matter that led to raising fines against the hospital. Later, it was found that the vaccine was compromised because of the improper storage at below freezing temperatures for 32 months.

Accordingly, the safe storage of the drugs and medicines under fixed temperature is a challenge. The absence of a software with alarm system that alerts the users regarding several information (such as the expiration date of the drug, the inappropriate conditions of storing the drug) is another challenge. The Medical Transport Bag allows the proper and safe storage of medicines and over the counter products at fixed temperature. This matter is very important for the health of the patients and can save a lot of lives. Several medicines can be ineffective or poisonous if were exposed to extreme temperatures or improper storage conditions.

Several inventions were registered in the United States Patent and Trademark Office (USPTO) regarding transport systems that work by cooling.

The current methods that are used by the patients don't allow safe storage of their drugs/medicine/over the counter products at fixed temperature under different conditions (cold- or warm- or room temperature) in the same unit.

In addition, the current methods that are used in the laboratories for transporting the samples and the reagents are not practical in all cases and don't maintain all the necessary parameters that I am mentioning in my invention (the Medical Transport bag) as the following:

First, None of the products in the market includes an alarm system that will alert the patient for the time of taking the medicine, for the expiration date of the drug. None of the products include a software in which these information can be stored by the user. Such alarm system is very important for the elderly in addition to its importance in the storage in the long term in the hospitals. The alarm system will be included in every compartment in the Medical Transport Bag. Accordingly, the patients can fill the information into software according to the compartment (cold- or warm- or room temperature compartment) and the preferred criteria in which the patients want to create a reminder using the alarm system.

Furthermore, many of the available coolers or storage devices that are available in the market works by pre-chilling an ice pack or a gel pack in the freezer before using the device. The devices are helpful but can have limitations for the elderly or for the person who forgets to pre-chill the ice pack in the freezer before the travel. Despite the fact that some products were manufactured with a built-in system in which there are saline packs in the device, the principle is the same as the whole bag needs to be placed in the freezer before using it.

Moreover, the use of the ice pack or the saline pack doesn't provide fixed temperature as the temperature starts to rise upon melting the material in the ice pack. Also, these devices are not necessarily practical for the users during travelling because it can be difficult to find a freezer to chill the ice packs.

One of the examples of the registered products is the thermoelectric-based refrigerator apparatus [the inventions of United States Patent Application Numbers: (U.S. Ser. No. 11/460,128) and (U.S. Ser. No. 08/674,686)]. This apparatus is very small and can store small number of vials at one condition (e.g. through cooling). It doesn't serve the goal of storing drugs and chemicals for the uses in research or at different conditions.

Additionally, this design is costly. The size of the bag is very small size and doesn't fit transporting many drugs meaning that the patient needs to have more than one bag.

In contrast, my invention provides a complete storage bag with 3 different kinds of compartments for storing the drugs. Also, the bag can be charged by a charger and this enables the user to charge the bag at home, in the car, in the airport or at any place using a portable or electric charger and will enable the user to store all the drugs at fixed temperature.

It, also, allows the storage of the drugs and other products in the long term with the possibility of choosing a desired temperature setting.

On the other hand, less parameter are controlled in the available apparatus in the market than the ones that the Medical transport bag is designed to monitor.

Furthermore, many researchers and patients, prefer/need to transport several drugs/samples in the same bag to save time, money and effort and to have a convenient way for the transport during travelling. The Medical Transport Bag has suitable sizes.

Finally, there is no indicator for the charge level and the temperature in many of the available devices. Feeling that the bag started to be warm is the only indicator for the change in the temperature in these devices.

In summary, the available products are relatively costly and aren't tailored to solve the problems that I am mentioning in this application and that encounter many researchers in the labs and many patients.

### OBJECT OF THE INVENTION (THE MEDICAL TRANSPORT BAG) & THE PROBLEMS THAT THE INVENTION SOLVES

Taking the necessary drugs and medications is important in preventing illness and saving the lives of several people in addition to maintaining health and providing symptom relief. These benefits can be only achieved if the drug was effective. Several reasons can lead to the use of ineffective drugs and can affect the health/lives of patients such as the improper use of the required dose or the improper storage of the drugs/medicines. Using degraded or compromised medicine (whether prescribed or not) is considered a big problem in the world.

Despite of the fact that the patient or the researcher can follow the storage instructions, there are conditions that are out of control and can affect the proper storage of the drug and other laboratory needs. For example, there is difference in the temperature and other conditions between the rooms in the same home/building (e.g. due to differences in the heating system/air conditioning, the number of the machines in the room, the quality of the machines in the room, the activities of the people inside the room & others).

Improper storage can decrease the potency of the drugs and medicines. The following are examples of the drugs that can be affected by the improper storage conditions:
A) Insulin, thyroid hormones and the suspended medications (that need shaking before use) lose their effectiveness if they were exposed to freezing or extreme hot temperature conditions.
B) Several medications can not be stored in the refrigerator because they can become clumpy, viscous or separate.
C) Repetitive heating and cooling can lead to the loss of the potency of certain drugs such as concentrated epinephrine.
D) The medications that are in aerosolised containers (such as Albuterol inhalers) can explode in temperatures that exceed 120 degrees.
E) The hydrocortison cream can separate and become ineffective in the heat. The proper storage of the hydrocortison cream is at room temperature and away from light, moisture and heat.
F) The protein based drugs (e.g. hormonal-based medicines, birth control medications and thyroids drugs) can be exposed to conformational changes if they were exposed to heat.
G) Heat has extreme effects on creams and ointments.
H) Vaccines need to be transported and stored at cold temperature at frozen storage in the long term to avoid changing the structure of the vaccine-antigen complex or the denaturation of the antigen.

The improper storage conditions can lead to adverse effects. Compromised aspirin can cause several problems in the stomach in addition to other symptoms while the use of compromised antibiotics can cause damage to the kidney or stomach.

As a result and in order to solve the previously mentioned problems and improve the methods that are currently used, it came to my mind to design a Medical Transport Bag.

The idea of the Medical Transport Bag is to manufacture a bag that can serve the goal of preserving the drugs and samples at fixed temperature at different conditions (cold- or warm- or room temperature) and prevent exposing the drug to fluctuations in the temperature at different times and different locations.

The bag will include an alarm system that will alert the patient for the time of taking the medicine and for other information (e.g. expiration date, the doses of the drugs and the improper conditions for storing the drugs) that can be stored in the software in every compartment of the bag. When the alarm starts, it will give a beep with a sound indicating the reason of the alarm (e.g. temperature, level of the charge, other information that is stored in the software of the bag . . . etc).

Accordingly, the Medical Transport Bag is very important in the cases of using emergency drugs such as insulin (for diabetes), the epinephrine auto injector (EpiPen), nitroglycerine (for heart diseases), seizure medications and anti-coagulants.

The Medical Transport Bag is also useful for the patients during their travel in the car, the airplane or in other forms of transportation. Travelling luggage is not safe for storing the drugs and medicines as there is no control for the temperature. Accordingly, having a bag for the carry-on medicines is useful and important.

The bag is also suitable for storing the medications of the elderly and the kids who may not notice the changes in the drug if it was stored improperly. It also prevents mixing their medications as the bag will have label and a place for the information and/or the picture of the patient and will remind them of important information that are stored in the computerized alarm system.

In addition, the design of the bag gives the user the opportunity to store the drugs and chemicals at room temperature, warm or cold temperature and this is a new feature that is not available in the products in the market. It also enables the patients to store their drugs with privacy.

Other advantage of the Medical Transport Bag is to allow the users to transport drugs and samples at different seasons, to different places (from one room to another or from one facility to another) at adjusted optimal conditions (temperature) without worrying about the changes in the conditions of the surrounding environment and their effects on the samples or the drugs.

These features are also important for the researchers who are conducting scientific experiments and not only the patients.

The Medical Transport Bag will have a display screen that shows the level of temperature and buttons for controlling or adjusting the level of the temperature.

### BRIEF DESCRIPTION OF THE DESIGN OF THE MEDICAL TRANSPORT BAG AND THE RELATED DRAWINGS

The Medical Transport Bag is an enclosed hollow cavity that is used to keep the drugs/samples in stabilized environment.

The idea of this invention is to design a portable chargeable Medical Transport Bag that is small in size, light in weight and cost effective for transporting all kinds of drugs and biological samples under monitored conditions in an affordable and a convenient way. The Medical Transport Bag is very useful for researchers in research laboratories and for the patients. It will be manufactured in different sizes.

FIG. 1 displays a diagram for the Medical Storage Transport Bag while FIGS. 2 and 3 show diagrams of the front and the back view of the big size of the Medical Transport Bag respectively. On the other hand, FIGS. 4 and 5 show diagrams of the front and the back view of the wallet/purse size of the Medical Transport Bag respectively.

The parts of the Medical Transport Bag (the big size and the wallet/purse size) in the front side are shown in FIG. 6 as the following:
Number 1: Handle of the Medical Transport Bag to allow carrying the bag easily
Number 2: Shoulder strap of the Medical Transport Bag to allow carrying the bag on the shoulder if the user prefers that.
Number 3 and 4 show 2 compartments (one compartment for storing the products at warm temperature and another for storing the products at cold temperature) in which each compartment can be closed by separate zippers (Numbers 8 and 9 separated by Number 10) so that every place can be closed and open separately. Every compartment has a digital screen that shows the parameters in the compartment of the Medical Transport Bag (Numbers 5 and 6).

The parts of the 2 sizes of the Medical Transport Bag in the back side are shown in FIG. 7: the room temperature compartment (Number 12) and its zipper (Number 13) to keep the compartment isolated and closed.

On the other hand, the front, back and side view of the Medical Transport Bag are shown in FIGS. 8 and 9 for the big size and the wallet/purse size respectively.

FIG. 12 illustrates the charger that can be plugged to a hole in the bag (Number 7 of FIG. 6) to charge the battery of the Medical Transport Bag that is located at the bottom of the bag (Number 11 of FIG. 6).

Furthermore, the warm and the cold compartments of the Medical Transport Bag will include built-in heat cycle (FIG. 11) and built-in cooling cycle (FIG. 10) respectively.

In order to achieve the above mentioned goals, several characteristics need to be provided in the Medical Transport Bag as described in the following paragraphs:

The Medical Transport Bag is a precision-designed bag that can be used for the transport of the samples/medicines under ideal balanced and monitored conditions.

The Medical Transport Bag will be manufactured using a fireproof and waterproof inert material.

The Medical Transport Bag is designed with separate zippers to close the bag. The sealing of the bag should be proper to isolate the interior environment of the bag from the external environment.

The Medical Transport Bag is designed with a handle so that the user can carry the bag easily, shoulder strap and a power switch.

The Medical Transport Bag will be arranged to work with a battery that can be charged by a charger/adapter. The battery can be charged using an electrical plug or by using an exterior portable battery adapter/charger that works outdoor (e.g. in the car or other place). The battery will placed in a waterproof compartment to ensure a safety design for the Medical Transport Bag.

The Medical Transport Bag will be equipped with an indicator for the charge level of the battery (e.g. full charge or half charge . . . etc). The charge level will be displayed in a digital screen located on the outside surface of the Medical Transport Bag.

The Medical Transport Bag has knobs (below the digital screen) that will allow the researcher to adjust the temperature according to the requirements of the experiment.

The researcher can press the button of the parameter that needs to be adjusted and then use the 2 arrows ( [symbol] ) to increase or decrease the readings according to the required conditions that are suitable for the medicines/samples.

The design of the Medical Transport Bag includes a digital screen on the outside surface of the bag. The screen will work as a readout display for the temperature. The screen will also display the charge level of the battery and other parameters.

The interior of the bag will include a control unit with temperature sensors (e.g. thermostat that controls the temperature and prompts the system to reach the desired temperature & thermometer that measures changes in the temperature and displays the current temperature) to adjust the temperature at fixed readings.

The temperature control mode in every compartment is designed to respond to the changes that are detected by the sensor when there is difference between the actual temperature and the required temperature. This system provides electrical power to the heating coil to adjust the temperature.

The Medical Transport Bag will include the hot cycle pump that circulates heat to create a flow of heat in the warm compartment of the bag (FIG. 11).

The cold compartment in the Medical Transport Bag will include the same major components of the fridge (FIG. 10). In more details, the Medical Transport Bag will include a generator (for creating the ammonia gas), condenser (for cooling the hot ammonia to be condensed in liquid form), evaporator (for evaporating the liquid ammonia to gas to facilitate the cold environment) and absorber (for absorbing the ammonia gas in water). The cycle will be working using the same gas that is used in the refrigerator (ammonia) in addition to the water and hydrogen.

The heating unit is composed of the fan which passes air to the evaporator so that the refrigerant evaporates. The vapour then passes to the electric compressor which increases the temperature and pressure of the vapour followed by passing the vapour to the exchanger to produce heat. Later, the condensed vapour goes through the expansion valve (its temperature and pressure are reduced) and the cycle repeats.

As a result, the portable bag is ideal for storing the temperature-sensitive medications and for other laboratory needs. The bag can be manufactured at the size of wallet/purse (small bag) or big Medical Transport Bag for the purpose of the safe storage and transport of the medications and laboratory needs at the large scale. This means that the researcher can choose the preferred design that saves the users money, time and effort.

The first size is the large medical storage bag (dimensions 10 in wide×7½ in high×2.5 in deep). The second size is the wallet/purse size (dimensions in 9.4 in wide×1.4 in high×5.1 in deep) which is mainly useful for the patients. The wallet/purse size is mostly suitable for the patients (more than researchers). The wallet can be easily placed in any bag (the suitcase, the school bag or the gym bag).

In addition, the Medical Transport Bag will be designed in attractive way by using different colors and/or scientific pictures outside the bag (like DNA or Neurons . . . etc) so that the bag looks as scientific bag or an attractive bag to the patients.

The user can use the disinfectant on regular basis to prevent contamination and infections inside the bag but has to sterilize the Medical Transport Bag once every week or every two weeks by using sterilization gases such as ozone and hydrogen peroxide gas.

### LIST OF FIGURES AND DRAWINGS

FIG. 1: A diagram for the Medical Storage Transport Bag

FIG. 2: Diagram of the front view of the big size of the Medical Transport Bag

FIG. 3: Diagram of the back view of the big size of the Medical Transport Bag

FIG. 4: Diagram of the front view of the Medical Transport Bag at the wallet/purse size

FIG. 5: Diagram of the back view of the Medical Transport Bag at the wallet/purse size

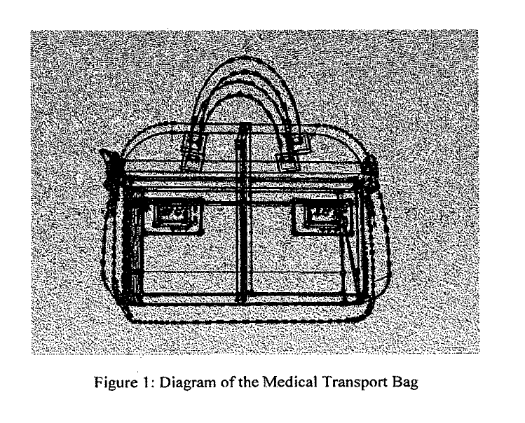

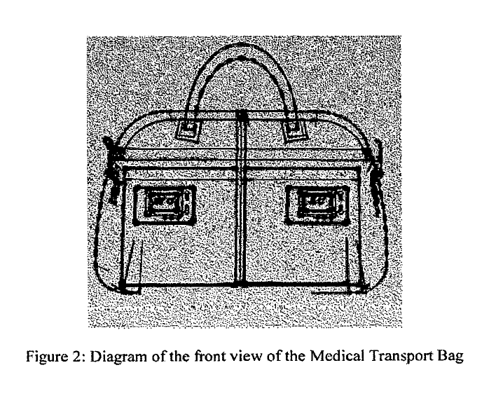

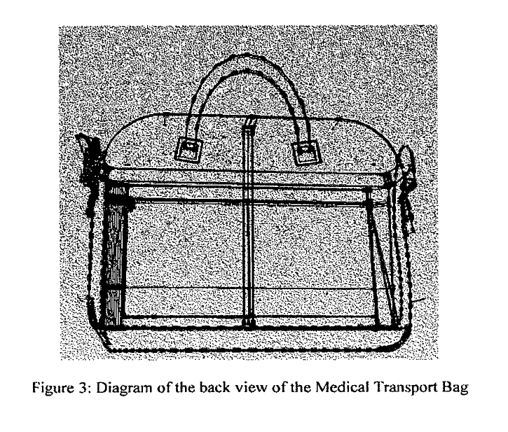

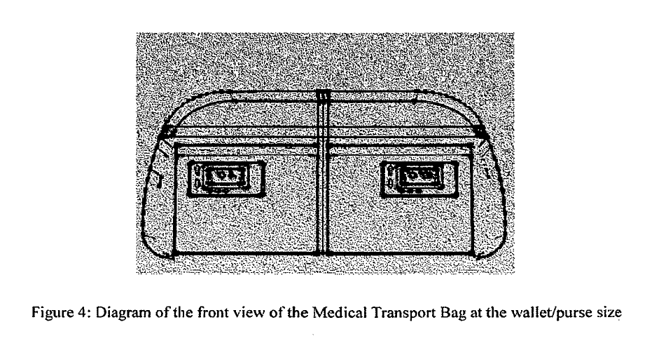

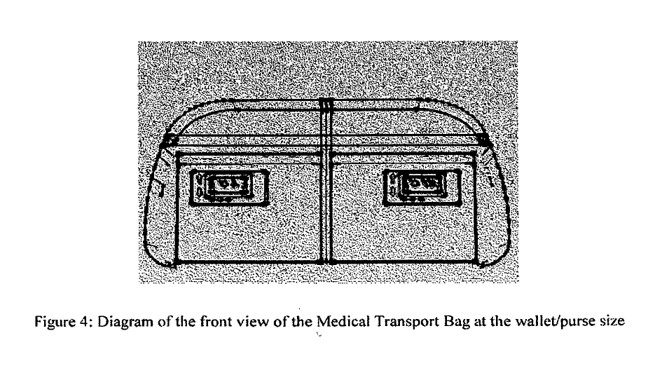

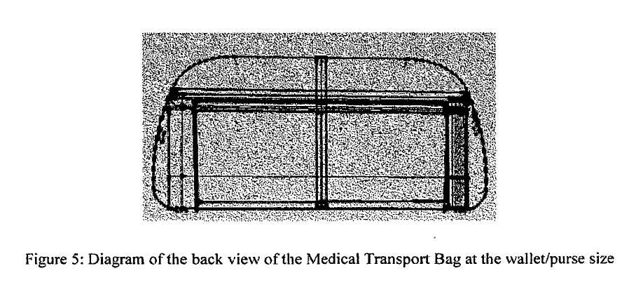

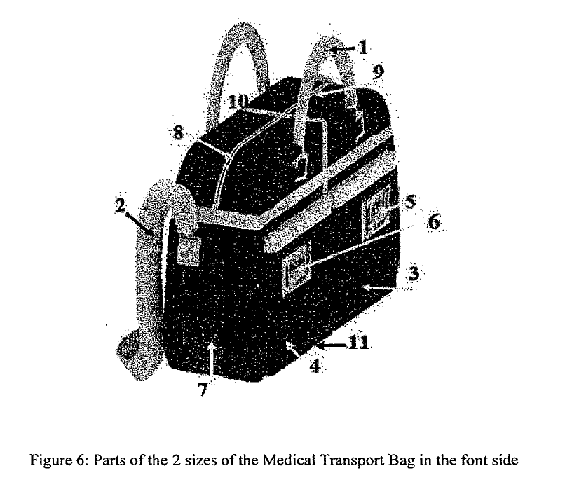

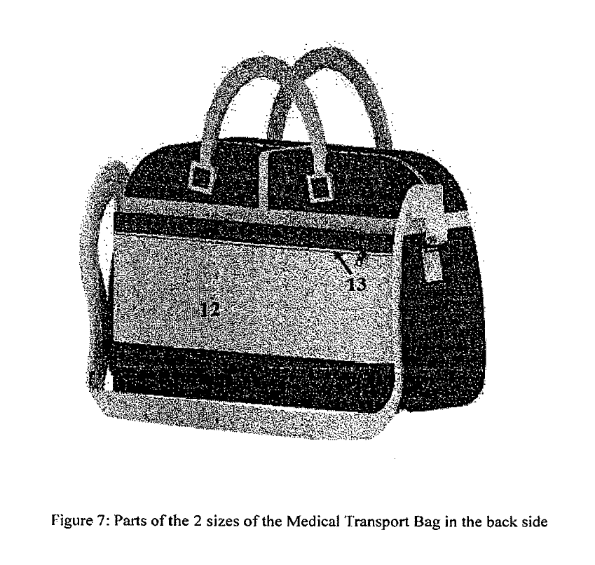

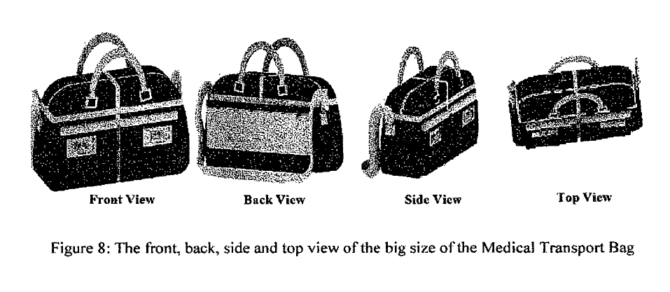

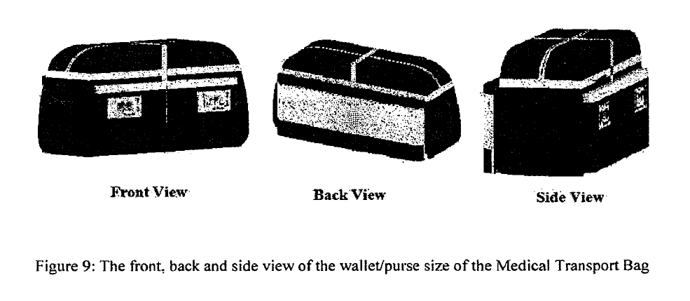

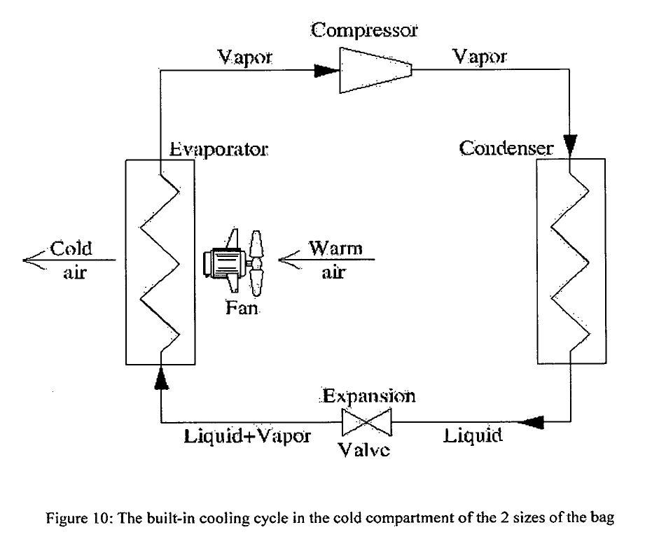

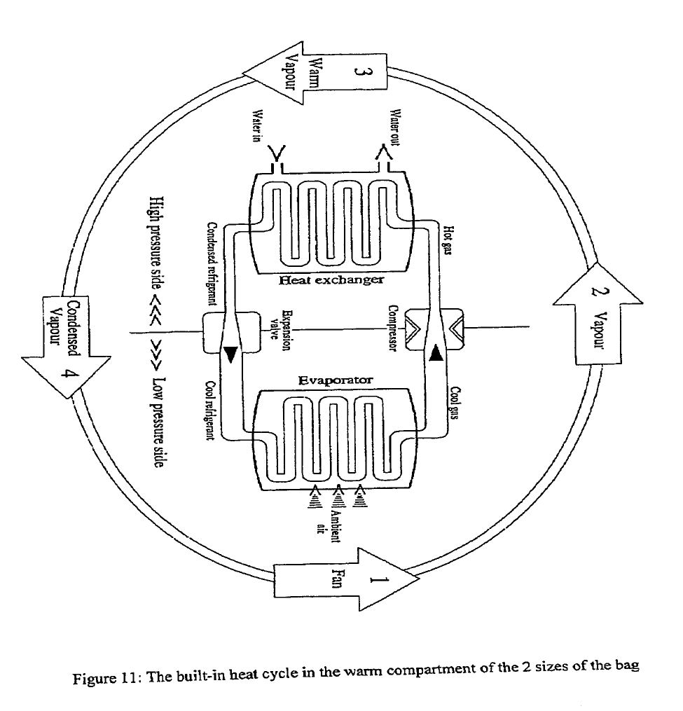

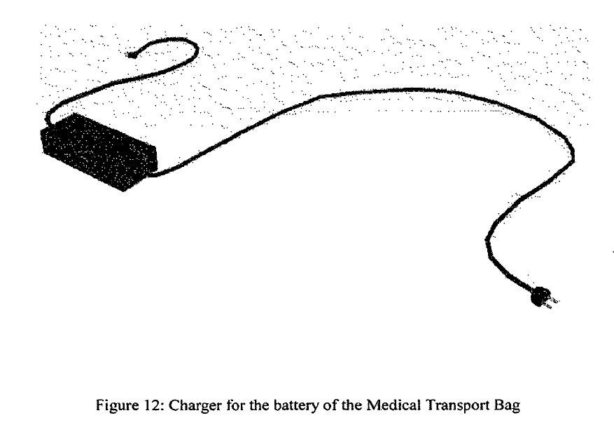

FIG. 6: Parts of the 2 sizes of the Medical Transport Bag in the front side
Number 1: Handle of the Medical Transport Bag to allow carrying the bag easily.
Number 2: Shoulder strap of the Medical Transport Bag to allow carrying the bag on the shoulder if the user prefers that.
Number 3: The cold compartment in the front side of the Medical Transport Bag
Number 4: The warm compartment in the front side of the Medical Transport Bag
Number 5: Digital screen that shows the parameters in the cold compartment of the Medical Transport Bag
Number 6: Digital screen that shows the parameters in the warm compartment of the Medical Transport Bag
Number 7: A hole for the adapter plug or the charger plug
Number 8: Zipper for the warm compartment of the Medical Transport Bag
Number 9: Zipper for the cold compartment of the Medical Transport Bag
Number 10: Separator for the 2 zippers (the zipper for the warm compartment and the zipper for the cold compartment) to allow opening the 2 compartments separately according to the stored drugs/products
Number 11: Battery of the Medical Transport Bag located at the bottom of the bag

FIG. 7: Parts of the 2 sizes of the Medical Transport Bag in the back side
Number 12 in FIG. 7: The room temperature compartment in the back side of the Medical Transport Bag
Number 13 in FIG. 7: Zipper for the room temperature compartment (to keep the compartment isolated and closed)

FIG. 8: The front, back, side and top view of the big size of the Medical Transport Bag

FIG. 9: The front, back and side view of the wallet/purse size of the Medical Transport Bag

FIG. 10: The built-in cooling cycle in the cold compartment of the 2 sizes of the bag

FIG. 11: The built-in heat cycle in the warm compartment of the 2 sizes of the bag

FIG. 12: Charger for the battery of the Medical Transport Bag

1. Portable Medical Transport Bag with delicate design that is cost effective and Environment friendly (use thermoelectric principle) for transporting all kinds of drugs/medicines, over the counter products and biological samples under adjusted balanced conditions (different ranges of temperature).
Wherein the Medical Transport Bag is made out of fireproof and waterproof inert material.
Wherein the Medical Transport Bag includes 2 separate built-in systems (for the heating and the cooling systems).
Wherein the Medical Transport Bag has a handle to allow carrying the bag easily.
Wherein the Medical Transport Bag has a shoulder strap to allow carrying the bag on the shoulder if the user prefers that.
Wherein the Medical Transport Bag has proper zipper to isolate the environment inside the bag from the external one and to isolate every compartment.
Wherein the Medical Transport Bag can be operated with a built-in 6000 mAh lithium battery that can be charged using a charger/adapter that has electrical plug or USB.
Wherein the battery/charger of the Medical Transport Bag has low power consumption (3 W battery and 5 W charger).
Wherein the Medical Transport Bag is suitable for storing the drugs at cold- or warm- or room temperature.
Wherein the Medical Transport Bag contains 3 separate compartments for every storing temperature (at cold- or warm- or room temperature).
Wherein the Medical Transport Bag includes knobs for adjusting the readings of the temperature
Wherein the Medical Transport Bag is equipped with a control system for monitoring the temperature.
Wherein the Medical Transport Bag contains a digital screen as a parameter display for the level of the temperature, the level of the charge and other parameters.
Wherein the Medical Transport Bag is supplemented with a label to avoid mixing the drugs of the patients (in the same home or unit).
Wherein the Medical Transport Bag provides privacy for the patient even if the patient used a shared fridge.
Wherein The Medical Transport Bag can be manufactured at two sizes: a big size for transporting drugs and products at the large scale and a wallet/purse size that is suitable for storing the drugs of the patients at different conditions.

2. The Medical Transport Bag contains a system that works through the heat cycle in the warm compartment and a system that works through the cooling cycle in the cold compartment.
Wherein the cold compartment in the Medical Transport Bag will include the same components of the fridge: a generator (for creating the ammonia gas), condenser (for cooling the hot ammonia to be condensed in liquid form), evaporator (for evaporating the liquid ammonia to gas to facilitate the cold environment) and absorber (for absorbing the ammonia gas in water).
Wherein the warm compartment in the Medical Transport Bag will include a heating unit that is composed of the fan (to pass air to the evaporator so that the refrigerant evaporates) then to the electric compressor (which increases the temperature and pressure of the vapour) followed by passing the vapour to the exchanger (to produce heat) and finally to the expansion valve and the cycle repeats.

3. The Medical Transport Bag is equipped with an alarm system that can alert the patient for the expiration date, the doses or the time of taking the drugs and other information) that the patient stored in the software of the bag.
